(19) United States
(12) Patent Application Publication
(10) Pub. No.: US 2014/0241123 A1
(43) Pub. Date: Aug. 28, 2014

(54) SYSTEM AND METHOD FOR LOCATING AND POSITIONING SEISMIC SOURCE

(71) Applicant: CGG SERVICES SA, Massy Cedex (FR)

(72) Inventors: John SALLAS, Plano, TX (US); Benoit TEYSSANDIER, Massy (FR); Robert DOWLE, Massy (FR)

(73) Assignee: CGG SERVICES SA, Massy Cedex (FR)

(21) Appl. No.: 14/163,227

(22) Filed: Jan. 24, 2014

Related U.S. Application Data
(60) Provisional application No. 61/767,861, filed on Feb. 22, 2013.

(51) Int. Cl. G01V 1/38

(52) U.S. Cl. CPC G01V 1/3817; G01V 1/3835
USPC 367/18; 367/16

(57) ABSTRACT

A source array generates seismic waves in water during a marine seismic survey. The source array includes a first sub-array including plural source elements; plural acoustic transceivers distributed along the first sub-array; a positioning system; a primary position control device configured to control a position of the first sub-array; and a secondary position control system configured to adjust a depth of the first sub-array.

### CROSS REFERENCE TO RELATED APPLICATIONS

This application claims priority and benefit from U.S. Provisional Patent Application No. 61/767,861 filed Feb. 22, 2013, for “A METHOD FOR LOCATING AND POSITIONING MARINE SEISMIC SOURCES,” the entire content of which is incorporated in its entirety herein by reference.

### BACKGROUND

1. Technical Field

Embodiments of the subject matter disclosed herein generally relate to the field of seismic data acquisition. In particular, the embodiments disclosed herein relate to a method and system for accurately locating a seismic source and also to positioning that seismic source on a desired travel path.

2. Discussion of the Background

Reflection seismology is a method of geophysical exploration to determine the properties of a portion of a subsurface layer in the earth, information that is especially helpful in the oil and gas industry. Marine reflection seismology is based on the use of a controlled source that sends energy waves into the earth. By measuring the time it takes for the reflections/refractions to come back to plural receivers, it is possible to estimate the depth and/or composition of the features causing such reflections/refractions. These features may be associated with subterranean hydrocarbon deposits.

For marine applications, a seismic survey system 100, as illustrated in FIG. 1, includes a vessel 102 that tows plural streamers 110 (only one is visible in the figure) and a seismic source 130. Streamer 110 is attached through a lead-in cable (or other cables) 112 to vessel 102, while source 130 is attached through an umbilical 132 to the vessel. A head float 114, that floats at the water surface 104, is connected through a cable 116 to a head end 110A of streamer 110, while a tail buoy 118 is connected through a similar cable 116 to a tail end 1108 of streamer 110. Head float 114 and tail buoy 118 maintain the streamer's depth and are also provided with GPS (Global Positioning System) or other communication equipment 120 for determining the streamer's position. In some seismic surveys, like for wide azimuth surveys, additional vessels not shown in FIG. 1 may tow separate source arrays that also shoot into the same streamers towed by the first vessel. Further, in other types of surveys, for example long offset surveys, other vessels may tow sources/streamers that emit/receive seismic signals from different vessels' sources/receivers.

In this regard, knowing the exact position of each sensor 122 (only a few are illustrated in FIG. 1 for simplicity) is important when processing the seismic data these sensors record. Thus, vessel 102 is also provided with GPS 124 and a controller 126 that collects the position data associated with streamer head and tail ends and also the position of the vessel and calculates, based on the streamer's known geometry, the absolute position of each sensor.

The same happens for source 130. A GPS system 134 is located on float 137 for determining the position of the source elements 136. Source elements 136 are connected to float 137 to travel at desired depths below the water surface 104. During operation, vessel 102 follows a predetermined path T while source elements (usually air guns) 136 emit seismic waves 140. These waves bounce off the ocean bottom 142 and other layer interfaces below the ocean bottom 142 and propagate as reflected/refracted waves 144 that are recorded by sensors 122. The positions of both the source element 136 and recording sensor 122 are estimated based on the GPS systems 120 and 134 and recorded together with the seismic data in a storage device 127 on board the vessel.

However, having a GPS system at the two ends of a 10 km long streamer does not produce accurate results for sensors 122 located far from both ends. To improve sensor location accuracy, modern seismic survey systems use acoustic transceivers 128 distributed along the streamer at known locations, and they interrogate adjacent transceivers located on neighboring streamers to detect the relative positions of each receiver along each streamer. Combined with traditional GPS, such a system is capable of providing more accurate sensor positioning.

More recently, an acoustic transceiver 138 has also been mounted on the float 137 of seismic source 130 and configured to communicate with the streamers' transceivers 128 to improve the accuracy of the source's position.

However, with the advance of vibratory sources, and the increasing size of source elements making up various sub-arrays of the seismic source, a GPS device with a transceiver unit is not enough to provide each source element's accurate location. Thus, there is a need for a system and method that provide enough accurate information about the positions of individual source elements making up the seismic source and also for quickly and efficiently adjusting the position of the seismic source if needed.

### SUMMARY

According to one embodiment, there is a source array for generating seismic waves in water during a marine seismic survey. The source array includes a first sub-array having plural source elements; plural acoustic transceivers distributed along the first sub-array; a positioning system; a primary position control device configured to control a position of the first sub-array; and a secondary position control system configured to adjust a depth of the first sub-array.

According to another embodiment, there is a source array for generating seismic waves in water during a marine seismic survey. The source array includes first and second sub-arrays including first source elements and second source elements; plural first acoustic transceivers distributed along the first sub-array; plural second acoustic transceivers distributed along the second sub-array; and positioning systems located on the first and second sub-arrays. The first acoustic transceivers are configured to communicate with the second acoustic transceivers and to measure relative distances.

According to still another embodiment, there is a source array for generating seismic waves in water during a marine seismic survey. The source array includes plural sub-arrays including corresponding source elements; plural acoustic transceivers distributed along each of the first and second sub-arrays; and a positioning system on at least one of the plural sub-arrays. The acoustic transceivers are configured to communicate among themselves to measure relative distances between the source elements.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a marine seismic survey acquisition system;

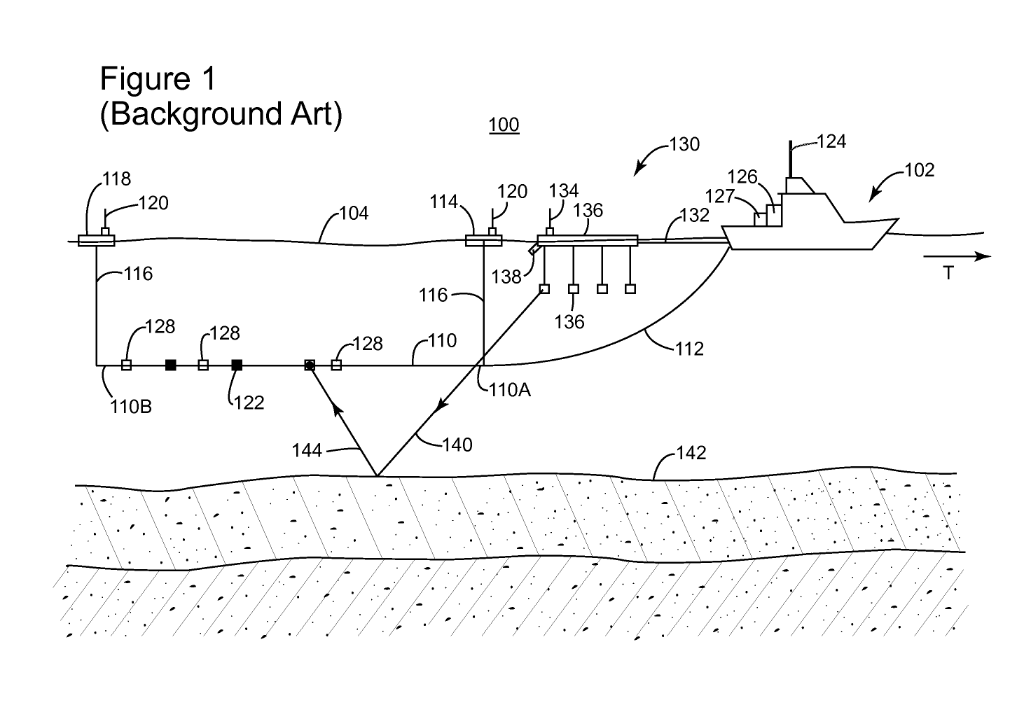

FIG. 2 is a schematic diagram of a seismic source array;

FIG. 3 is a side view of a sub-array having plural transceivers;

FIG. 4 is a top view of three sub-arrays having transceivers for determining locations of seismic source elements;

FIG. 5 is a top view of a seismic source array having an additional source and corresponding receiver for measuring the speed of sound in water;

FIG. 6 is a side view of a sub-array having a secondary position control system for positioning a source element;

FIGS. 7A-B illustrate different implementations of a secondary position control system;

FIG. 8 is a cross-sectional view of a source element;

FIG. 9 is a schematic diagram of a multi-level source array;

FIG. 10 is a schematic diagram of a variable-depth streamer;

FIG. 11 is a flowchart of a method for processing seismic data acquired with a source array as illustrated in one or more of the above figures; and

FIG. 12 is a schematic diagram of a control device.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a source sub-array including plural vibratory source elements attached to a float and configured to generate acoustic energy in a marine environment. However, the embodiments to be discussed next are not limited to vibratory source elements attached to a float; they may be applied to source elements attached to a buoy or floating due to a propulsion system and also to any type of sources of seismic waves.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an exemplary embodiment, acoustic transceivers are distributed along one or more seismic sub-arrays of a source array and configured to interact with each other for determining accurate positions of the source elements making up the seismic sub-arrays. This data is collected at a towing vessel together with GPS information and used, together or not, to determine accurate positions of each source element. At least an additional source and receiver may be mounted on one or more sub-arrays for determining the speed of sound in water. The speed of sound in water is used aboard the vessel to improve the location of the seismic source elements. Additional corrections, like corrections related to vessel velocity and source velocity, may be incorporated to further improve accuracy.

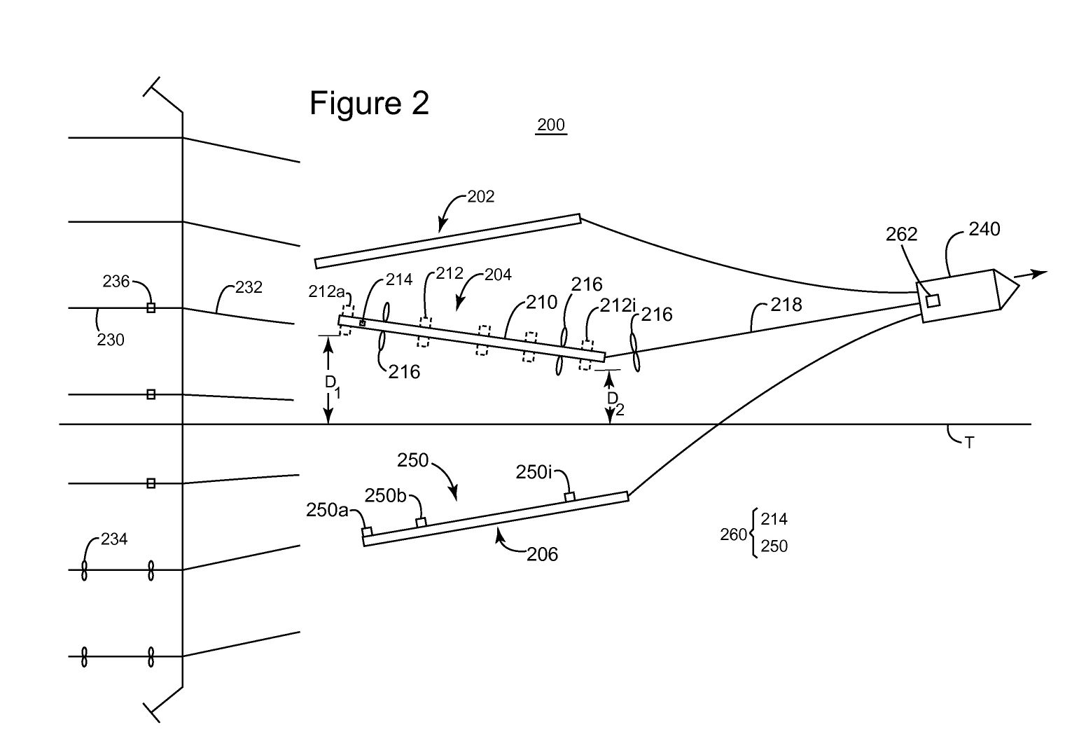

Prior to introducing the novel concepts, a short discussion about a seismic source array and the problems posed by having many source elements is in order. A bird's view of a source array 200 is illustrated in FIG. 2, and it includes three sub-arrays 202, 204 and 206, each having a float 210 from which seismic source elements 212 are suspended. FIG. 2 illustrates how each source sub-array (e.g., a longitudinal axis of float 210) makes an angle with a traveling direction T, so that a first source element 212a is farther away (by a cross-line distance D1) than a last source element 212i (by a cross-line distance D2) from traveling direction T. A positioning system 214 located on float 210 (or on the vessel or on a buoy attached to the vessel, source or streamers) may determine a location of a first source element. If the positioning system 214 is a GPS system, it may accurately determine the position of the first source element 212a, which is located next to the GPS system, but not the location of the last source element 212i (and other source elements that are far from the GPS location) relative to traveling direction T. Although a primary position control system 216 may be located along float 210 and/or umbilical 218, e.g., one or more birds having adjustable wings, this system may be slow in adjusting the position of the entire sub-array (which may weight tons) and may also be useless if the float's angle with the traveling path is unknown. In this regard, note that GPS system 214 cannot provide any information about the angle made by the sub-array with traveling path T. FIG. 2 also shows streamers 230 not parallel with traveling path T. Streamers 230 are connected to vessel 240 through lead-ins 232 (which are partially shown, so as not to clutter the figure). Birds 234 are distributed along each streamer for positioning them based on measurements generated by the acoustic transceivers 236. In other cases, the sources that comprise the sub-array may be configured to be approximately neutrally buoyant in the water, and the source elements in each sub-array are not suspended from a float at the surface, instead one or more birds may be used to control the position of the source elements in the towed source sub-array. For this case, a buoy equipped with a GPS receiver and acoustic transceiver that may or may not be attached to the same sub-array and may be towed to provide a geodetic datum point. Alternatively, the GPS receiver is located on the vessel.

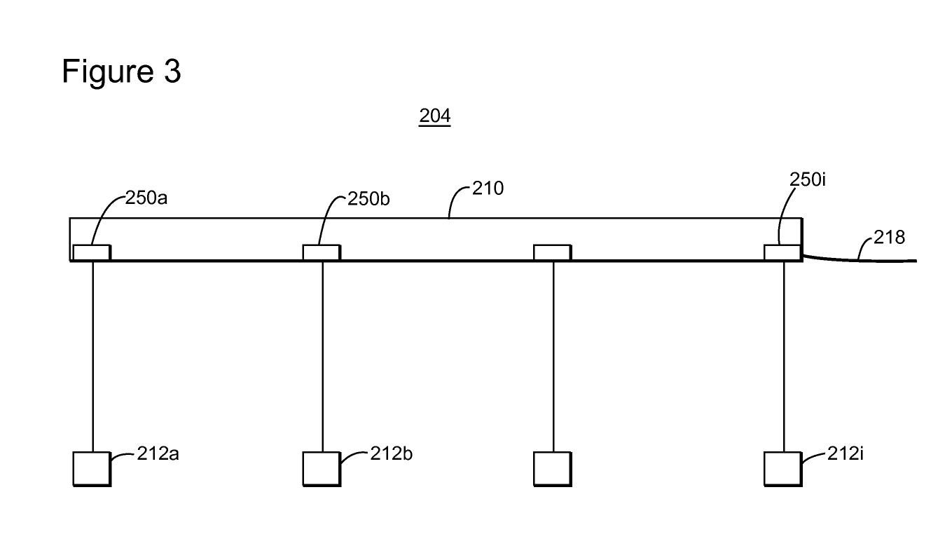

According to an embodiment, a system 250 of acoustic transceivers 250i may be distributed along each sub-array for determining accurate distances between the source elements. Note that an acoustic transceiver is a device capable of generating, transmitting and receiving an acoustic wave. FIG. 3 shows a side view of sub-array 204 having an acoustic transceiver 250i for each source element 212i. In this embodiment, the acoustic transceivers are located on the float, vertically above the source elements. In another embodiment, fewer acoustic transceivers than the number of source elements may be located on the float. In still another embodiment, for improved accuracy, the acoustic transceivers are located on the source elements and not on the float. In still another embodiment, the positions of the source elements do not coincide with the positions of the acoustic transceivers, but their relative geometry is known. In still another embodiment, only two acoustic transceivers per float are provided.

In one application, the acoustic transceivers are located by each source element and not all at the surface. It is possible to have at least one positioning device (e.g., GPS receiver, or microwave receiver as discussed later) on each sub-array, or on a buoy(s) near the sub-arrays to provide geodetic datum points. In one application, the positioning receivers (e.g., GPS) are not co-linear, so one towed sub-array might have a positioning receiver near the front of the line and another sub-array has its positioning receiver at the rear of the line. To obtain a good fix on the position of each acoustic transceiver, in one application, an acoustic transceiver communicates, preferably, with at least four other transceivers that are not co-planar to obtain an accurate position in 3 dimensions. While having a positioning receiver (GPS, microwave, etc.) on each sub-array increases the accuracy of locating the source elements, in one application it is possible to have a single positioning receiver located on one of the sub-arrays, a buoy attached to one of the sub-arrays or on the vessel. In this case, the relative positions of the source elements are determined with the acoustic transceivers and their absolute positions are then calculated based on the positioning receiver's position and the known geometry of the source array.

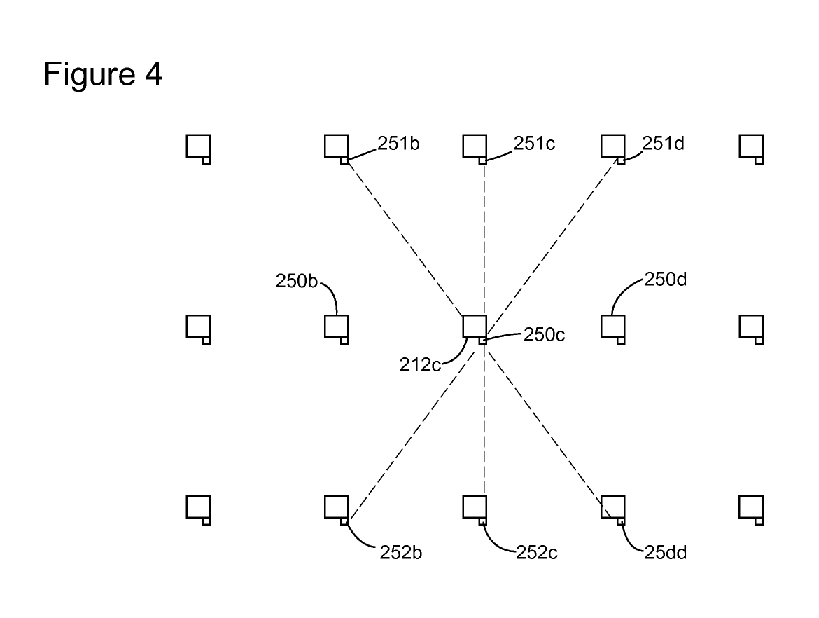

FIG. 4 shows an embodiment in which the acoustic transceivers are attached to the source elements, and they communicate among themselves for establishing the source elements' relative positions. Note that acoustic transceiver 250c may communicate with neighboring acoustic transceivers 251b-d and/or 252b-d. A protocol used by the acoustic transceivers for communication is disclosed, for example, in U.S. Patent Application Publication No. 2010/0329075, entitled, “Method for Assistance in the Localization of Towed Streamer Comprising A Step of Defining and A Step For Generating Distinct Acoustic Cycles,” the entire content of which is incorporated herein by reference. Other protocols may be used. Note that all this information may be transmitted to a global controller located on the vessel or distributed at the source sub-arrays, which calculates the position of each source element.

In another embodiment, a source array's glide path or trajectory is predetermined. The glide path can be selected so that the source elements follow a depth profile that ignores swells, or one that tracks dynamic depth and includes the effect of swells and wave height. One or more positioning receivers (e.g., GPS receiver) equipped with ultrasonic acoustic transceivers may be located at the air/water boundary on towed buoys. The various marine acoustic source elements are also equipped with ultrasonic transceivers. A range-finding system 260 as illustrated in FIG. 2 (e.g., a Sercel system that measures the travel times between ultrasonic transceivers) may include GPS system 214 and system 250 of acoustic transceivers. A control system 262, located on vessel 240, may receive GPS and acoustic data from the range-finding system 260 to calculate source elements' absolute positions, i.e., to estimate the position of each source array element relative to the GPS receivers at the surface and also its position relative to other source elements. Control system 262 may also receive information from the streamers and may calculate source elements' relative positions to ultrasonic transceivers located at nodes on the towed streamers.

Source element position measurement accuracy may be improved by using redundant and/or multiple measurements that are either averaged or combined in a manner that uses a priori information or other statistics (for example, an error covariance matrix) to weight the various position measurements before averaging. In other words, control system 262 may be configured to use various mathematical algorithms for combining positioning receiver and acoustic transceiver measurements.

The above embodiments have been discussed assuming that one or more of the positioning receivers (e.g., GPS receivers) are provided on the sub-arrays or the towing vessel. In one application, instead of using GPS receivers, it is possible to use an alternative system. For example, this alternative system may be a microwave ranging system. The microwave ranging system may include microwave antennas mounted on towers located on the vessel and microwave receivers located on the sub-arrays, for example, in places where GPS receivers are located in the previous embodiments. In one application, microwave receives have their antenna mounted above water, on the floats or buoys. In another application, the microwave antennas may be located on a balloon attached to the vessel, or on oil platform or located on land for surveys that are performed near the coastline.

In still another embodiment, to improve distance measurements using ultrasonic transceivers, a source and receiver can be collocated near one or more of the transceivers to measure the speed of sound in the water. This source may be similar to the source array source elements. In one application, this additional source is different from the source elements. In another application, the additional source is smaller in size than the other source elements. This measurement improves distance measurements' accuracy because water's sound speed varies with water temperature, salinity, pressure, air content, etc. Traditionally, the speed of sound in water is considered to be constant. However, seismic surveys take place all over the world, from the equator to the poles and, thus, water temperature needs to be taken into account. Further, air content in water may greatly depend on, among other things, the amount of air the vessel's propellers are inducing. If the source elements and receivers used to measure the speed of sound in water move at the same velocity, this sound speed measurement will be unaffected by the motion of the source elements and receivers. However, acoustically determined distance measurements between acoustic transceivers may need to take into account the relative velocities of the transceivers; this correction can be made using various methods, e.g., at the transceiver by measuring the Doppler frequency shift to ascertain the velocity correction, or by making a two-way measurement and averaging.

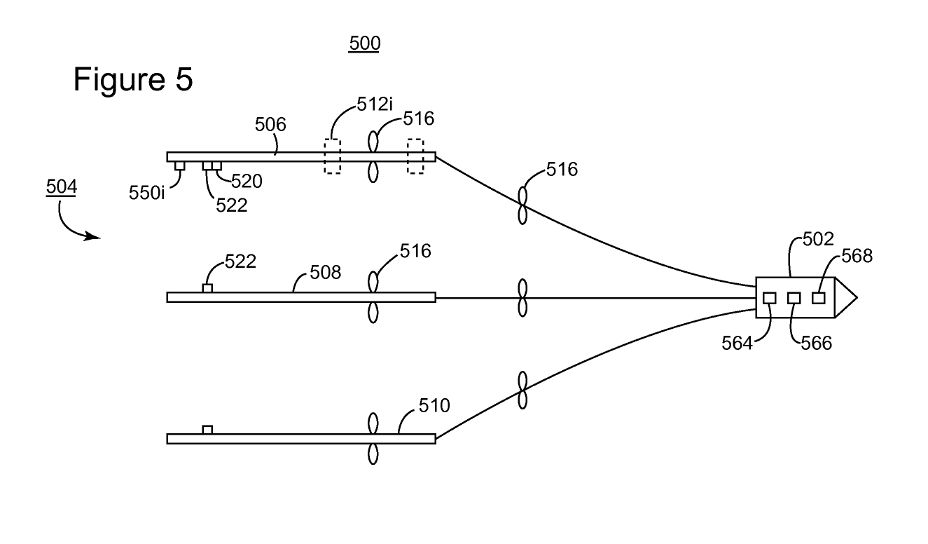

For these reasons, according to the embodiment illustrated in FIG. 5, a seismic survey system 500 includes a vessel 502 that tows a seismic source array 504 that includes three seismic sub-arrays 506, 508 and 510. At least one seismic sub-array 506 has an additional source 520 attached to its float or a source element. Source 520 may be similar to acoustic source elements 512i or it may be a pinger or other similar source. In one application, source 520 is an ultrasonic source. However, in another embodiment, source 520 is an acoustic source whose emission frequency is lower in frequency and better suited for long distance ranging than an ultrasonic source. In one application, source 520 has a frequency, for example, in the range of 200-500 Hz, which is higher than the source elements discussed herein, but still in the range of the hydrophones used in the streamers. Thus, this signal could be a way to range between the sources and the streamer hydrophones without interfering with seismic acquisition. In one application, source 520 is smaller than source elements 512i. A sensor 522 may be co-located with acoustic source 520 or it may located on another sub-array, or both. A wave emitted by additional source 520 is detected by sensor 522. The emitted wave is directly detected by sensor 522, i.e., without bouncing first from the ocean bottom (when sensor 522 is located on an adjacent sub-array). Alternatively, it is possible to record the emitted wave after it has bounced off the ocean bottom or off of the water surface.

Thus, control system 564 may calculate the speed of sound in water and use this accurate speed when using the positioning receiver (e.g., GPS) and acoustic transceiver's data for calculating each source element's absolute position. The position of all source elements is logged on a recording system 566 also located on the seismic vessel. An error signal may be computed by control system 564 for each source element's position, and the error signal is indicative of the difference between a source element's estimated current position and the desired position as prescribed by the glide path. The position error for each source element is then used to compute (either in control system 564 or navigation system 568 of vessel 502) a command signal that varies the settings for the various control surfaces on the position control device 516 (e.g., bird) that are either rigidly attached to each source float or located on the umbilical nearby.

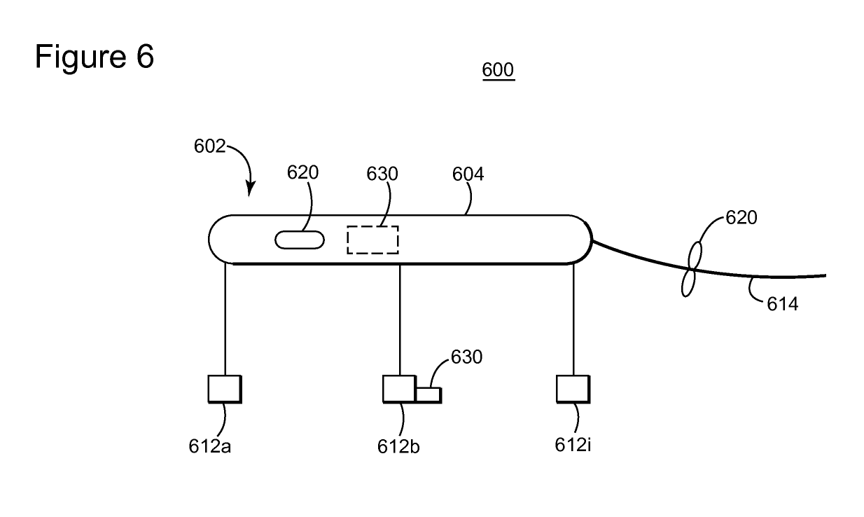

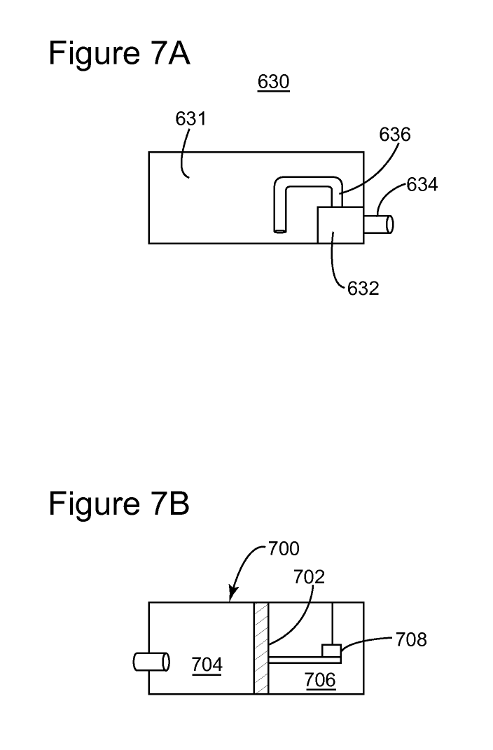

In yet another embodiment, to help reduce the work of the main position control device, a secondary position control system may be implemented and configured to work in tandem with the main position control device to help control glide depth. FIG. 6 shows a seismic source 600 in which a sub-array 602 includes a float 604 and plural source elements 612i. Sub-array 602 is towed by a vessel (not shown) through umbilical 614. One or more main position control devices 620 are located either on the float or the umbilical. A secondary position control system 630 may be also positioned on the float 604 or umbilical 614 or on a corresponding source element 612i. For example, secondary position control system may be a ballast tank as illustrated in FIG. 7A. Water is either added or removed from an enclosure 631 of the ballast tank using a pump 632. Pump 632 may have a water input 634 and a water output 636. Alternatively, the secondary position control system may be just a cylinder 700 and piston 702, as illustrated in FIG. 7B, that separates a first chamber 704 filled with water from a second chamber 706 filled with air. A force is provided by an actuator 708 (electric or pneumatic) for changing a position of piston 702 in and out of the cylinder to change the air to water volume ratio. By changing this ratio, the secondary position control system changes the corresponding source element's depth. In still another application, it is possible to have winches on the floats to raise and lower the sources. Alternatively, if the sources are configured to be neutrally buoyant in the water, depth and position control may be controlled by one or more birds in each sub-array.

Another option for the secondary position control system is to have a bladder with a pneumatic valve attached so compressed air can be added or vented from the bladder, thereby changing the system's overall weight, which helps the primary position control device lift or lower the source array or source element.

One example of a vibratory source element was described in U.S. patent application Ser. No. 13/415,216 (herein the '216 application), filed on Mar. 8, 2012, and entitled, “Source for Marine Seismic Acquisition and Method,” assigned to the same assignee as the present application, the entire content of which is incorporated herein by reference. This is only one possibility for a source element. Other source element designs may be used.

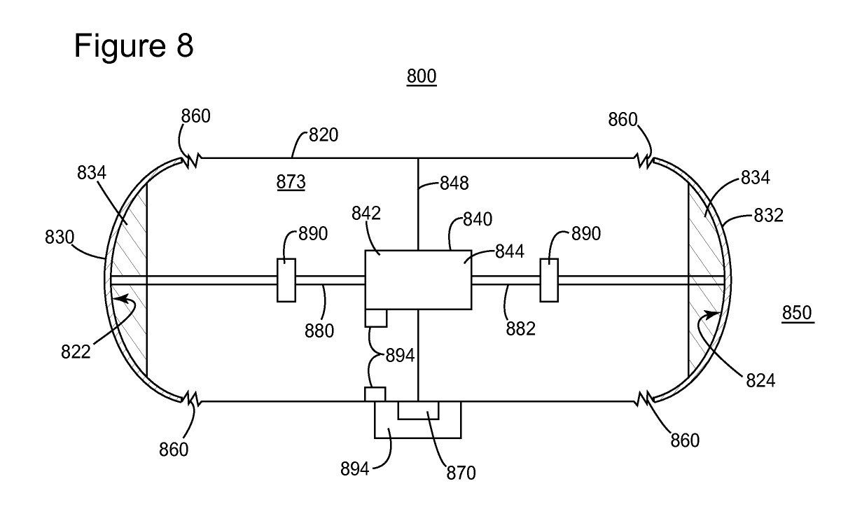

The structure of this exemplary vibratory source element is now discussed with regard to FIG. 8. A seismic vibro-acoustic source element is a unit capable of producing an acoustic wave. A source element may have an electro-magnetic linear actuator system configured to drive a piston (or a pair of pistons). However, it is possible to have a hydraulic, pneumatic, magnetostrictive or piezoelectric actuator or other appropriate mechanisms instead of the electro-magnetic actuator. Each source element may be driven by an appropriate pilot signal. A pilot signal is designed as a source array target signal such that the total array far-field output follows a desired target power spectrum. A drive signal derived from the pilot signal is applied to each source element. A pilot signal may have any shape, e.g., pseudo-random, cosine or sine, increasing or decreasing frequency, etc.

According to the embodiment illustrated in FIG. 8, a source element 800 has a housing 820 that together with pistons 830 and 832 enclose an electro-magnetic actuator system 840 and separate it from the ambient 850, which might be water. Although FIG. 8 shows two movable pistons 830 and 832, note that a source element may have one piston or more than two pistons.

Housing 820 may be configured as a single enclosure as illustrated in FIG. 8, with first and second openings 822 and 824 configured to be closed by pistons 830 and 832. However, in another embodiment, housing 820 may include two or more enclosures. A single actuator system 840 may be configured to simultaneously drive pistons 830 and 832 in opposite directions for generating seismic waves, as illustrated in FIG. 8. In one application, pistons 830 and 832 are rigid, i.e., made of a rigid material, and they are reinforced with rigid ribs 834. Actuator system 840 may include one or more individual electro-magnetic actuators 842 and 844. Other types of actuators may be used. Irrespective of how many individual actuators are used in source element 800, actuators are provided in pairs configured to act simultaneously in opposite directions on corresponding pistons to prevent a “rocking” motion of the source element. Note that it is undesirable to “rock” the source element when generating waves because the source element should follow a predetermined path when towed in water.

Actuator system 840 may be attached to housing 820 by an attachment 848. Various other components described elsewhere are illustrated in FIG. 8, and they may include a sealing 860 provided between the pistons and the housing, a pressure regulation mechanism 870 configured to balance the external pressure of the ambient 850 with a pressure of a fluid 873 enclosed by housing 820 (enclosed fluid 873 may be air or other gases or mixtures of gases), one shaft (880 and 882) per piston to transmit the actuation motion from the actuation system 840 to pistons 830 and 832, a guiding system 890 for the shafts, a cooling system 894 to transfer heat from the actuator system 840 to ambient 850, a local control device 894, etc.

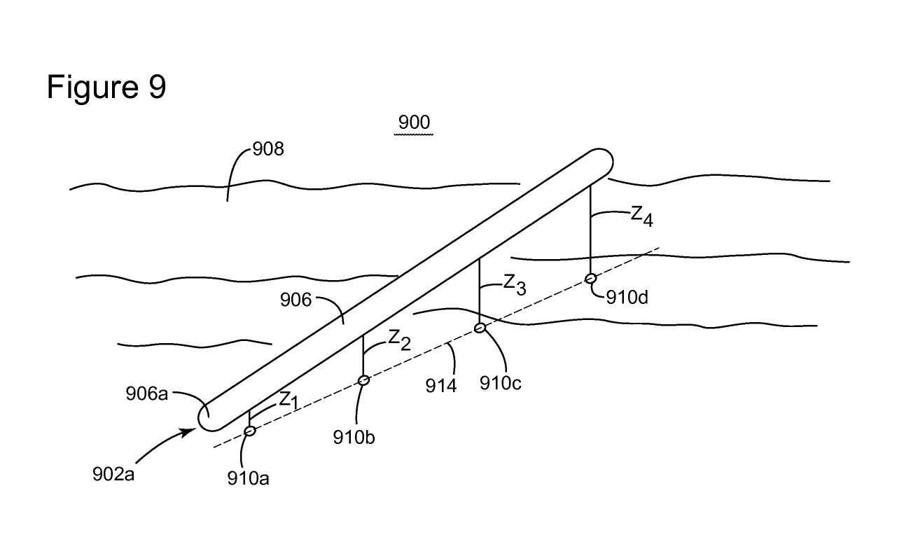

Although the previous figures have shown each sub-array with a horizontal distribution, note that a multi-level source may be used. For example, a multi-level source 900 is illustrated in FIG. 9 as having one or more sub-arrays. The first sub-array 902 has a float 906 configured to float at the water surface 908 or underwater at a predetermined depth. Plural source elements 910a-d are suspended from float 906 in a known manner. A first source element 910a may be suspended closest to head 906a of float 906, at a first depth z1. A second source element 910b may be suspended next, at a second depth z2, different from z1. A third source element 910c may be suspended next, at a third depth z3, different from z1 and z2, and so on. FIG. 9 shows, for simplicity, only four source elements 910a-d, but an actual implementation may have any desired number of source points. In one application, because the source elements are distributed at different depths, the source elements at the different depths are not simultaneously activated. In other words, the source array is synchronized, i.e., a deeper source element is activated later in time (e.g., 2 ms for 3 m depth difference when the speed of sound in water is 1500 m/s) so that corresponding sound signals produced by the plural source elements coalesce, and the overall sound signal produced by the source array appears to be a single sound signal. In one embodiment, the high-frequency source elements are simultaneously activated in a flip-flop mode with low-frequency source elements. In another embodiment, all the source elements are simultaneously activated with incoherent, coded signals so the recorded seismic signals can be separated based on the source element that emitted that signal.

The depths z1 to z4 of the source elements of the first sub-array 902 may obey various relationships. In one application, the depths of the source elements increase from the head toward the tail of the float, i.e., z1<z2<z3<z4. In another application, the depths of the source elements decrease from the head to the tail of the float. In another application, the source elements are slanted, i.e., provided on an imaginary line 914. In still another application, line 914 is a straight line. In yet another application, line 914 is a curved line, e.g., part of a parabola, circle, hyperbola, etc. In one application, the depth of the first source element for sub-array 902 is about 5 m and the greatest depth of the last source element is about 8 m. In a variation of this embodiment, the depth range is between 8.5 and 10.5 m or between 11 and 14 m. In another variation of this embodiment, when line 914 is straight, source element depths increase by 0.5 m from one source element to an adjacent source element. Those skilled in the art would recognize that these ranges are exemplary and these numbers may vary from survey to survey. A common feature of all these embodiments is that the source elements have variable depths so that a single sub-array exhibits multiple-level source elements.

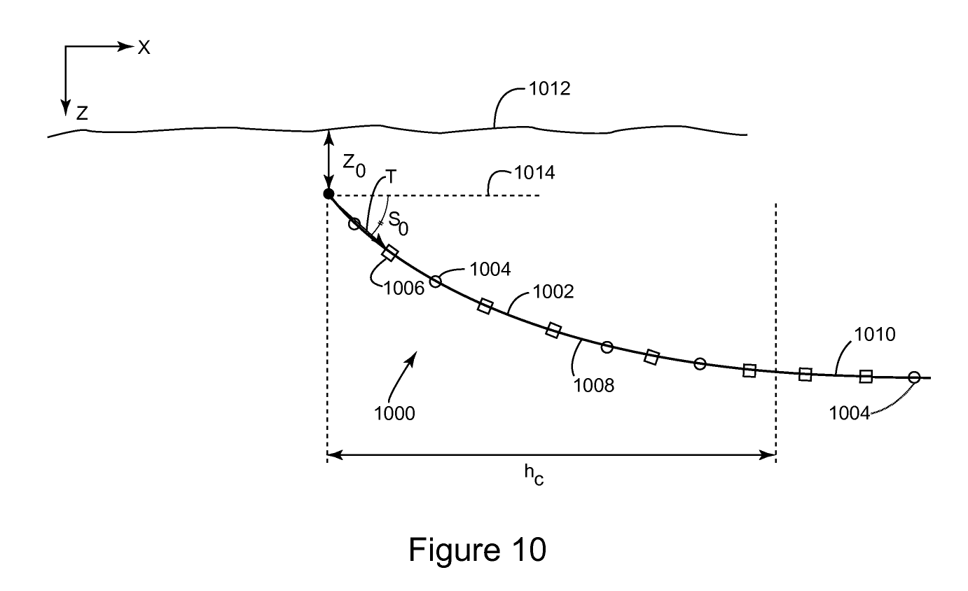

The above embodiments were discussed without specifying what type of seismic receiver is used to record the seismic data. In this sense, it is known in the art to use, for a marine seismic survey, streamers towed by one or more vessels, and the streamers include seismic receivers. Streamers may be horizontal, slanted or have a curved profile as illustrated in FIG. 10.

The curved streamer 1000 of FIG. 10 includes a body 1002 having a predetermined length, plural detectors 1004 provided along the body, and plural birds 1006 provided along the body for maintaining the selected curved profile. The streamer is configured to flow underwater when towed such that the plural detectors are distributed along the curved profile. The curved profile may be described by a parameterized curve, e.g., a curve described by (i) a depth z₀ of a first detector (measured from the water surface 1012), (ii) a slope s₀ of a first portion T of the body with an axis 1014 parallel with the water surface 1012, and (iii) a predetermined horizontal distance h_{c} between the first detector and an end of the curved profile. Note that not the entire streamer has to have the curved profile. In other words, the curved profile should not be construed to always apply to the entire length of the streamer. While this situation is possible, the curved profile may be applied only to a portion 1008 of the streamer. In other words, the streamer may have (i) only a portion 1008 having the curved profile or (ii) a portion 1008 having the curved profile and a portion 1010 having a flat profile, with the two portions attached to each other.

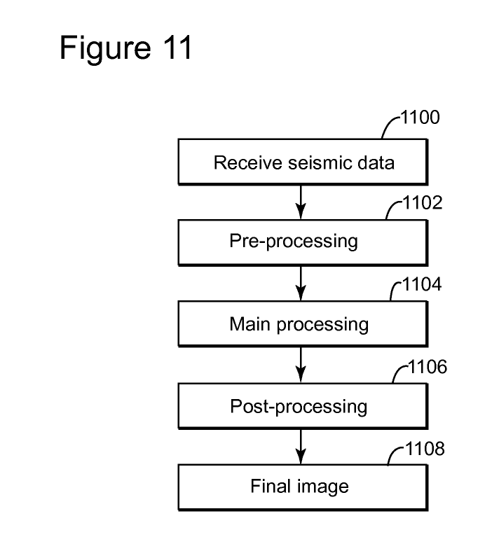

Seismic data generated by the seismic sources discussed above and acquired with the streamers noted in FIG. 10 may be processed in a corresponding processing device for generating a final image of the surveyed subsurface. For example, seismic data generated with the source elements as discussed with regard to FIGS. 2 to 6 may be received in step 1100 of FIG. 11 at the processing device. In step 1102 pre-processing methods are applied, e.g., demultiple, signature deconvolution, motion correction, trace summing, vibroseis correlation, resampling, etc. In step 1104 the main processing takes place, e.g., deconvolution, amplitude analysis, statics determination, common middle point gathering, velocity analysis, normal move-out correction, muting, trace equalization, stacking, noise rejection, amplitude equalization, etc. In step 1106, final or post-processing methods are applied, e.g. migration, wavelet processing, inversion, etc. In step 1108 the final image of the subsurface is generated.

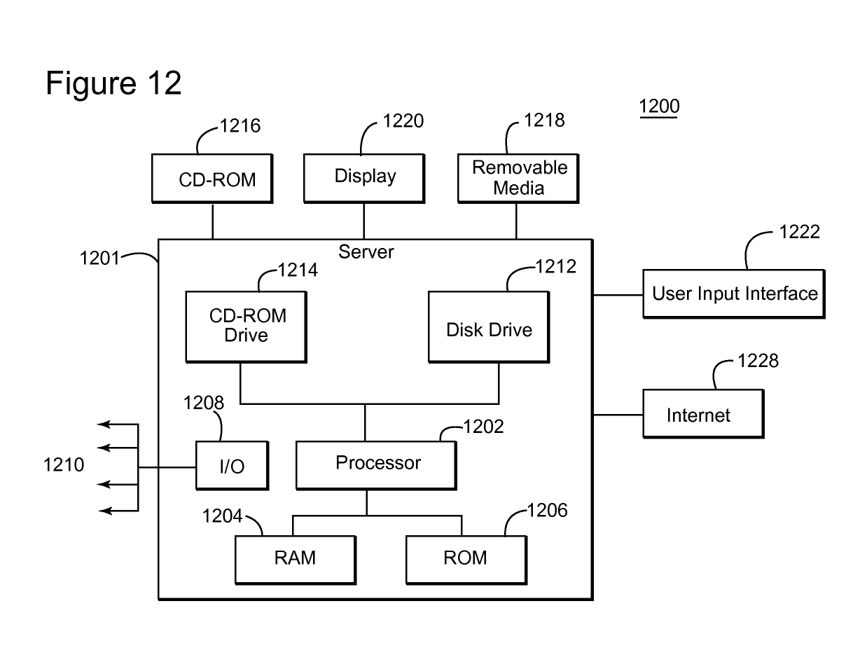

An example of a representative processing device capable of carrying out operations in accordance with the embodiments discussed above is illustrated in FIG. 12. Hardware, firmware, software or a combination thereof may be used to perform the various steps and operations described herein. The processing device 1200 of FIG. 12 is an exemplary computing structure that may be used in connection with such a system, and it may implement any of the processes and methods discussed above or combinations of them.

The exemplary processing device 1200 suitable for performing the activities described in the exemplary embodiments may include server 1201. Such a server 1201 may include a central processor unit (CPU) 1202 coupled to a random access memory (RAM) 1204 and to a read-only memory (ROM) 1206. The ROM 1206 may also be other types of storage media to store programs, such as programmable ROM (PROM), erasable PROM (EPROM), etc. Processor 1202 may communicate with other internal and external components through input/output (I/O) circuitry 1208 and bussing 1210, to provide control signals and the like. For example, processor 1202 may communicate with the sensors, electro-magnetic actuator system and/or the pressure mechanism of each source element. Processor 1202 carries out a variety of functions as are known in the art, as dictated by software and/or firmware instructions.

Server 1201 may also include one or more data storage devices, including disk drives 1212, CD-ROM drives 1214, and other hardware capable of reading and/or storing information, such as a DVD, etc. In one embodiment, software for carrying out the above-discussed steps may be stored and distributed on a CD-ROM 1216, removable media 1218 or other form of media capable of storing information. The storage media may be inserted into, and read by, devices such as the CD-ROM drive 1214, disk drive 1212, etc. Server 1201 may be coupled to a display 1220, which may be any type of known display or presentation screen, such as LCD, plasma displays, cathode ray tubes (CRT), etc. A user input interface 1222 is provided, including one or more user interface mechanisms such as a mouse, keyboard, microphone, touch pad, touch screen, voice-recognition system, etc.

Server 1201 may be coupled to other computing devices, such as the equipment of a vessel, via a network. The server may be part of a larger network configuration as in a global area network (GAN) such as the Internet 1228, which allows ultimate connection to the various landline and/or mobile client/watcher devices.

As also will be appreciated by one skilled in the art, the exemplary embodiments may be embodied in a wireless communication device, a telecommunication network, as a method or in a computer program product. Accordingly, the exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer-readable medium may be utilized, including hard disks, CD-ROMs, digital versatile discs (DVD), optical storage devices or magnetic storage devices such a floppy disk or magnetic tape. Other non-limiting examples of computer-readable media include flash-type memories or other known types of memories.

The disclosed exemplary embodiments provide a source array, seismic vibro-acoustic source element and a method for determining a position of each source element and also, if necessary, controlling a trajectory of the source elements. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A source array for generating seismic waves in water during a marine seismic survey, the source array comprising:
a first sub-array including plural source elements;
plural acoustic transceivers distributed along the first sub-array;
a positioning system;
a primary position control device configured to control a position of the first sub-array; and
a secondary position control system configured to adjust a depth of the first sub-array.

2. The source array of claim 1, wherein the plural source elements are suspended from a float and the plural acoustic transceivers are distributed along the float.

3. The source array of claim 2, wherein there is an acoustic transceiver for each source element.

4. The source array of claim 1, wherein the positioning system is a Global Positioning System or a microwave based system.

5. The source array of claim 1, further comprising:
a control device configured to communicate with the plural acoustic transceivers and to determine an absolute position of each source element based on information received from the plural acoustic transceivers and the positioning device.

6. The source array of claim 1, wherein each plural acoustic transceiver is configured to interrogate adjacent acoustic transceivers for measuring corresponding distances.

7. The source array of claim 1, further comprising:
a second sub-array having corresponding acoustic transceivers that communicate with the plural acoustic transceivers of the first sub-array,
wherein the positioning system is located on the first sub-array and another global positioning system is located on the second sub-array.

8. The source array of claim 7, further comprising:
a control device configured to communicate with the plural acoustic transceivers of the first sub-array and with the acoustic transceivers of the second sub-array and to determine an absolute position of each source element of the first and second sub-arrays based on information received from the plural acoustic transceivers of the first sub-array, the acoustic transceivers of the second sub-array, and the positioning device.

9. The source array of claim 1, further comprising:
a supplementary source on the first sub-array; and
a sensor located on the first sub-array,
wherein the sensor records seismic waves generated by the supplementary source for determining the water speed.

10. The source array of claim 9, wherein the supplementary source and the sensor are located on the float.

11. The source array of claim 9, wherein the supplementary source is located on a source element of the first sub-array.

12. The source array of claim 9, wherein the sensor or the supplementary source is located on the first sub-array and the other one is located on a second sub-array.

13. The source array of claim 1, wherein the secondary position control system is located on an umbilical of the first sub-array.

14. The source array of claim 1, wherein the secondary position control system is located on the float or on each source element.

15. The source array of claim 14, wherein the secondary position control system is configured to change a ratio between its mass and volume to adjust its depth.

16. A source array for generating seismic waves in water during a marine seismic survey, the source array comprising:
first and second sub-arrays including first source elements and second source elements;
plural first acoustic transceivers distributed along the first sub-array;
plural second acoustic transceivers distributed along the second sub-array; and
positioning systems located on the first and second sub-arrays,
wherein the first acoustic transceivers are configured to communicate with the second acoustic transceivers and to measure relative distances.

17. The source array of claim 16, further comprising:
a controller configured to receive the relative distances from the first and second acoustic transceivers and positions from the positioning systems and to calculate absolute positions of the first and second source elements.

18. The source array of claim 16, further comprising:
a primary position control device configured to control a position of the first sub-array; and
a secondary position control system configured to adjust a depth of the first sub-array.

19. The source array of claim 16, further comprising:
a supplementary source on the first sub-array; and
a sensor located on the first sub-array,
wherein the sensor records seismic waves generated by the supplementary source for determining the water speed.

20. A source array for generating seismic waves in water during a marine seismic survey, the source array comprising:
plural sub-arrays including corresponding source elements;
plural acoustic transceivers distributed along each of the first and second sub-arrays; and
a positioning system on at least one of the plural sub-arrays,
wherein the acoustic transceivers are configured to communicate among themselves to measure relative distances between the source elements.
